(19) United States
(12) Patent Application Publication
(10) Pub. No.: US 2026/0124701 A1
(43) Pub. Date: May 7, 2026

(54) LASER WELDING DEVICE AND LASER WELDING METHOD

(71) Applicant: Panasonic Intellectual Property Management Co., Ltd., Osaka (JP)

(72) Inventors: Jingbo WANG, Hyogo (JP); Masatoshi NISHIO, Osaka (JP); Toshihiro OSUMI, Hyogo (JP); Kenzo SHIBATA, Hyogo (JP); Atsuki YAMAMOTO, Osaka (JP)

(21) Appl. No.: 19/442,289

(22) Filed: Jan. 7, 2026

Related U.S. Application Data
(63) Continuation of application No. PCT/JP2024/022975, filed on Jun. 25, 2024.

(30) Foreign Application Priority Data
Jul. 14, 2023 (JP) 2023-116130

(51) Int. Cl. B23K 26/21

(52) U.S. Cl. CPC B23K 26/21

(57) ABSTRACT

A laser welding device includes a first laser oscillator configured to generate a first laser beam, a second laser oscillator configured to generate a second laser beam, and a processing head configured to irradiate a workpiece with the first laser beam and the second laser beam. The first laser beam and the second laser beam are radiated substantially in parallel at a prescribed interval in a direction along a welding direction. The second laser beam is radiated toward a keyhole formed by the first laser beam.

### CROSS-REFERENCE TO RELATED APPLICATIONS

This is a continuation of International Application No. PCT/JP2024/022975 filed on Jun. 25, 2024, and claims priority from Japanese Patent Application No. 2023-116130 filed on Jul. 14, 2023, the entire content of which is incorporated herein by reference.

### TECHNICAL FIELD

The present disclosure relates to a laser welding device and a laser welding method.

### BACKGROUND ART

Patent Literature 1 discloses a laser beam generation method in which laser beams are combined at a fiber end of a multi-clad fiber, particularly a double-clad fiber, and emitted from the other fiber end of the multi-clad fiber to generate output laser beams having different beam profile characteristics. In the laser beam generation method, input laser beams are optically coupled to at least a fiber core of the multi-clad fiber or at least one ring core of the multi-clad fiber, or the laser beams are at least coupled to the fiber core of the multi-clad fiber and at least coupled to at least one ring core.

### CITATION LIST

### Patent Literature

Patent Literature 1: US2013/0223792A

### Non-Patent Literature

Non Patent Literature 1: Nakamura, Improvement of Welding Quality by Beam Profile Control BrightLine Weld, Proceedings of 91st Laser Processing Society Conference, (2019), p. 87-91.

### SUMMARY OF INVENTION

The present disclosure is made in view of circumstances in the related art, and provides a laser welding device and a laser welding method that more effectively prevent welding defects such as porosity or spatter.

The present disclosure provides a laser welding device including a first laser oscillator configured to generate a first laser beam, a second laser oscillator configured to generate a second laser beam, and a processing head configured to irradiate a workpiece with the first laser beam and the second laser beam. The first laser beam and the second laser beam are radiated substantially in parallel at a prescribed interval in a direction along a welding direction. The second laser beam is radiated toward a keyhole formed by the first laser beam.

Further, the present disclosure provides a laser welding method performed by a laser welding device including a first laser oscillator configured to generate a first laser beam, a second laser oscillator configured to generate a second laser beam, and a processing head configured to irradiate a workpiece with the first laser beam and the second laser beam. The laser welding method includes radiating the first laser beam and the second laser beam substantially in parallel at a prescribed interval in a direction along a welding direction, and radiating the second laser beam toward a keyhole formed by the first laser beam.

According to the present disclosure, welding defects such as porosity or spatter can be more effectively prevented.

### BRIEF DESCRIPTION OF DRAWINGS

FIG. 1 shows a schematic configuration example of a laser welding device according to Embodiments 1 and 2;

FIG. 2 schematically shows a configuration example of a processing head in Embodiment 1;

FIG. 3 shows an example of a positional relationship between a first laser beam and a second laser beam relative to a weld line;

FIG. 4 is a top view showing an arrangement example of the first laser beam and the second laser beam;

FIG. 5 is an AA-AA cross-sectional view showing an example of a melt pool and a keyhole in Embodiments 1 and 2;

FIG. 6 shows a first scanning trajectory example of the second laser beam;

FIG. 7 shows a second scanning trajectory example of the second laser beam;

FIG. 8 shows a third scanning trajectory example of the second laser beam;

FIG. 9 shows a fourth scanning trajectory example of the second laser beam;

FIG. 10 shows a first scanning speed example of the second laser beam;

FIG. 11 shows a second scanning speed example of the second laser beam;

FIG. 12 schematically shows a configuration example of a processing head in Embodiment 2; and

FIG. 13 shows an example of a melt pool and a keyhole in the related art.

### DESCRIPTION OF EMBODIMENTS

### Background of Present Disclosure

Laser light has a high power density, can perform high-speed and high-quality welding, and is applied to welding of various workpieces. Various types of processing heads are used for laser welding. A highly functional device such as a Galvano head that can scan a welding point of a workpiece with laser light (in other words, a laser beam) at high speed is used instead of a simple device that includes a collimator lens and a focus lens and has a fixed optical axis.

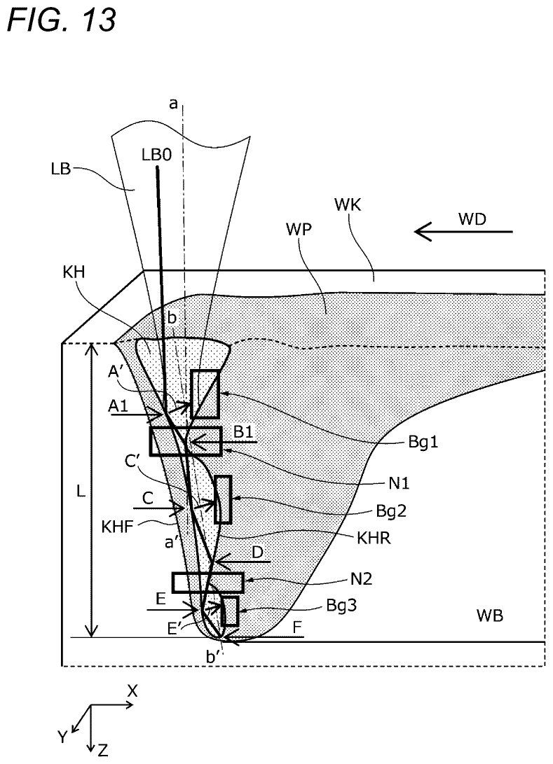

Here, a keyhole KH formed by a laser processing method in the related art will be described. FIG. 13 shows an example of a melt pool WP and the keyhole KH in the related art. The keyhole KH shown in FIG. 13 shows an instantaneous shape for easy understanding of description, and the present disclosure is not limited thereto.

When the laser power density is sufficiently high, the keyhole KH having a depth L is formed in the melt pool WP by a laser beam LB. Although not shown, the depth L of the keyhole KH is substantially equal to a penetration depth of a weld bead WB. The laser beam LB is absorbed while being multiply reflected by inner walls of the keyhole KH. When laser welding is performed while moving a processing head HD, a front wall KHF of the keyhole KH located on a welding direction WD side of the inner walls of the keyhole KH has a prescribed inclination angle relative to the laser beam LB and absorbs the laser beam LB. On the other hand, a rear wall KHR of the keyhole KH located on a side opposite to the welding direction WD side of the inner walls of the keyhole KH vibrates due to evaporation of molten metal generated on the front wall KHF of the keyhole KH while absorbing the laser beam reflected by the front wall KHF, and thus a shape is more unstable.

As indicated by a laser beam LB0, the laser beam LB is, after entering the keyhole KH, multiply reflected at each of points A1, C, and E on the front wall KHF of the keyhole KH and each of points B1 and D on the rear wall KHR, and is absorbed at a bottom portion (point F) of the keyhole KH.

Although not shown in FIG. 13, the laser beam LB (energy) which is not absorbed by the keyhole KH of the radiated laser beam LB is multiply reflected again by each of the front wall KHF and the rear wall KHR of the keyhole KH and exits to an outside of the keyhole KH, resulting in a loss.

At the same time as when the laser beam LB is absorbed at each of the points A1, C, and E on the front wall KHF of the keyhole KH, intense evaporation A′, C′, and E′ occurs. The front wall KHF of the keyhole KH is a fairly thin molten metal layer, and a solid part of a workpiece WK is present in a vicinity of the molten metal layer. On the other hand, the rear wall KHR of the keyhole KH is a thick molten metal (melt pool WP).

Therefore, as compared with the front wall KHF, the soft and thick molten metal (melt pool WP) of the rear wall KHR is more likely to be deformed by forces of the intense evaporation A′, C′, and E′, and the shape is unstable. As a result, in the rear wall KHR, a bulge Bg1 is formed at an opening of the keyhole KH formed in a surface of the workpiece WK, and bulges Bg2, Bg3 are similarly formed inside the keyhole KH. Further, since the rear wall KHR moves irregularly and intensely, constricted portions N1, N2 are formed in contrast to the bulges Bg1 to Bg3.

In a vicinity of the constricted portions N1, N2, the front wall KHF and the rear wall KHR come into contact with each other and close due to an intense movement of the rear wall KHR of the keyhole KH, thereby forming closed spaces (cavities) in a lower part in a depth direction thereof. The formed cavities are bubbles in the melt pool WP. When the bubbles cannot escape to the outside of the melt pool WP before the molten metal solidifies, porosity (welding defects) would be formed in the workpiece WK. In addition, when the keyhole KH in a state in which such closed spaces (cavities) are formed is irradiated with the laser beam LB to form the keyhole KH again, the entire keyhole KH moves intensely, and thus the molten metal may be scattered to form spatter.

In this manner, a keyhole is easily formed since laser has high power density in actual laser processing, and an unstable shape of the keyhole formed in the related art may cause porosity or spatter.

Therefore, as a method for solving the problem in a welding process caused by the keyhole, various methods are proposed in the related art (Patent Literature 1 and Non-Patent Literature 1). For example, Patent Literature 1 discloses a method for creating various beam profiles by controlling an incident position of a beam to be introduced into a double-clad fiber and applying the beam profiles to laser welding. Non-Patent Literature 1 reports spatter reduction effects by the method proposed in Patent Literature 1. However, a beam profile created for each fiber is limited once the fiber is formed, and thus there is a limit to an application range for these methods.

Therefore, in following embodiments, examples of a laser welding device and a laser welding method that more effectively prevent welding defects such as porosity or spatter will be described.

Hereinafter, the embodiments specifically disclosing the laser welding device and the laser welding method according to the present disclosure will be described in detail with reference to the drawings as appropriate. However, unnecessarily detailed description may be omitted. For example, detailed description of well-known matters and redundant description of substantially the same configuration may be omitted. This is to avoid redundancy in following description and facilitate understanding of those skilled in the art. The accompanying drawings and the following description are provided for those skilled in the art to fully understand the present disclosure, and are not intended to limit subject matters described in the claims.

### Embodiment 1

A laser welding device 100 according to Embodiment 1 radiates each of a plurality of laser beams (first laser beam LB1 and second laser beam LB2) from a processing head HD toward a workpiece WK, and reduces porosity or spatter in a melt pool WP formed in the workpiece WK.

### <1. Configurations of Laser Welding Device>

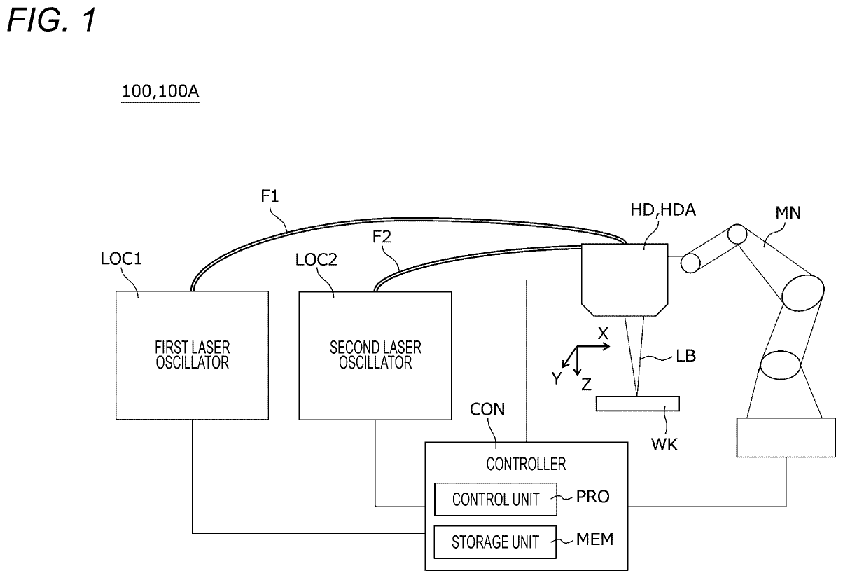

FIG. 1 shows a schematic configuration example of laser welding devices 100, 100A according to Embodiments 1 and 2. The laser welding device 100 includes a first laser oscillator LOC1, a second laser oscillator LOC2, two optical fibers F1, F2, the processing head HD, a manipulator MN, and a controller CON. The laser welding device 100A according to Embodiment 2 will be described later, and description thereof will be omitted here.

In following description, a direction in which the workpiece WK is irradiated with the first laser beam LB1 and the second laser beam LB2 from the processing head HD is referred to as a Z direction, and two directions constituting a plane direction orthogonal to the Z direction are referred to as an X direction and a Y direction.

The first laser oscillator LOC1 is a laser light source that is supplied with electric power from a laser driving power supply (not shown) and generates the first laser beam LB1. The first laser oscillator LOC1 may include a single laser light source or may include a plurality of laser modules.

The second laser oscillator LOC2 is a laser light source that is supplied with electric power from a laser driving power supply (not shown) and generates the second laser beam LB2. The second laser oscillator LOC2 may include a single laser light source or may include a plurality of laser modules.

The laser light source or the laser module used in each of the first laser oscillator LOC1 and the second laser oscillator LOC2 is appropriately selected according to a material of the workpiece WK that is a workpiece to be welded, a shape of a welding portion, and the like.

For example, a fiber laser, a disk laser, or an Yttrium Aluminum Garnet (YAG) laser can be used as the laser light source. In this case, wavelengths of the first laser beam LB1 and the second laser beam LB2 are set in a range of 1000 nm to 1100 nm.

For example, a semiconductor laser may be the laser light source or the laser module. In this case, the wavelength of the laser beam LB is set in a range of 800 nm to 1000 nm. A visible light laser may also be the laser light source or the laser module. In this case, the wavelengths of the first laser beam LB1 and the second laser beam LB2 are set in a range of a blue wavelength band of 420 nm to 500 nm and a green wavelength band of 480 nm to 560 nm. A wavelength λ1 of the first laser beam LB1 is preferably equal to or greater than a wavelength λ2 of the second laser beam LB2 (λ1≥λ2).

The optical fiber F1 has one end side (incident end) optically coupled to the first laser oscillator LOC1, and the other end side (emission end) optically coupled to the processing head HD, has a core (not shown) at an axial center, and is provided with cladding (not shown) that is coaxial with the core and is in contact with an outer peripheral surface of the core. The core and the cladding each contain quartz as a main component, and a refractive index of the core is higher than a refractive index of the cladding. For this reason, the first laser beam LB1 generated by the first laser oscillator LOC1 is incident on the incident end of the optical fiber F1, and is transmitted while being repeatedly reflected inside the core toward the emission end. The cladding is provided with, on an outer peripheral surface thereof, a coating (not shown) or a resin-based protective layer (not shown) that mechanically protects the optical fiber F1.

One end side (incident end) of the optical fiber F2 is optically coupled to the second laser oscillator LOC2, and the other end side (emission end) is optically coupled to the processing head HD. The optical fiber F2 has a core (not shown) at an axial center, and cladding (not shown) is provided coaxially with the core in contact with an outer peripheral surface of the core. The core and the cladding each contain quartz as a main component, and a refractive index of the core is higher than a refractive index of the cladding. For this reason, the second laser beam LB2 generated by the second laser oscillator LOC2 is incident on the incident end of the optical fiber F2, and is transmitted while being repeatedly reflected inside the core toward the emission end. A coating (not shown) or a resin-based protective layer (not shown) for mechanically protecting the optical fiber F2 is provided on an outer peripheral surface of the cladding.

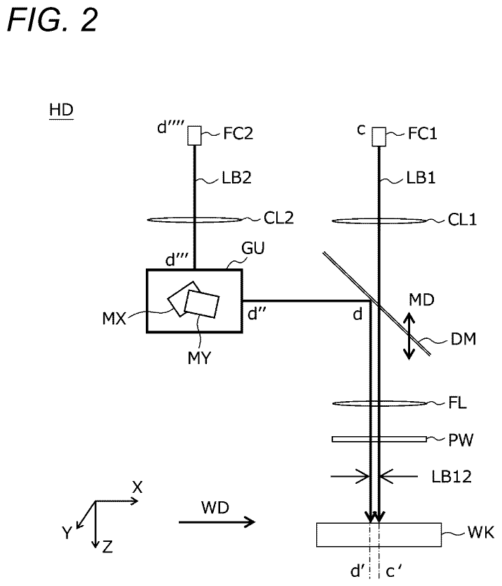

The processing head HD is attached to the emission ends of the optical fibers F1, F2 and accommodates at least one optical element and protective glass PW. An internal configuration example of the processing head HD according to Embodiment 1 will be described in detail with reference to FIG. 2. The processing head HD temporarily collimates the first laser beam LB1 and the second laser beam LB2 transmitted and spread via the respective optical fibers F1, F2 into parallel light. The processing head HD combines and focuses the collimated parallel light, transmits the light through the protective glass PW, and irradiates the workpiece WK with the light as the first laser beam LB1 and the second laser beam LB2. Accordingly, the processing head HD can process the workpiece WK by laser welding.

The manipulator MN is, for example, a known vertical six-shaft robot having six joint shafts. The sixth joint shaft is provided at a distal end of a robot arm of the manipulator MN. The manipulator MN can grip the processing head HD with a gripping component (not shown) from the sixth joint axis, and controls a position of the processing head HD such that the processing head HD is movable based on a command signal transmitted from the controller CON.

The controller CON includes a control unit PRO implemented by a processor or the like, and a storage unit MEM implemented by a memory or the like. The controller CON controls timing, output, start, end, and the like of laser oscillation of each of the first laser oscillator LOC1 and the second laser oscillator LOC2.

Specifically, the controller CON controls laser oscillation and laser output in the control unit PRO by supplying control signals such as an output current and an on and off time to a laser driving power supply (not shown) connected to each of the first laser oscillator LOC1 and the second laser oscillator LOC2. Further, the controller CON controls the position of the processing head HD via a driver (not shown) according to contents of a processing program stored in the storage unit MEM for performing laser welding (processing) on the workpiece WK. Further, the controller CON generates a command signal for controlling operation of the manipulator MN and sends the command signal to the manipulator MN.

The storage unit MEM stores a processing program for laser welding. As shown in FIG. 1, the storage unit MEM may be provided inside the controller CON, or may be provided outside the controller CON and exchange data with the controller CON. The storage unit MEM stores information on a scanning trajectory of the second laser beam LB2 taught in advance by a teaching pendant (not shown) or the like.

### <2. Configuration Example of Processing Head>

Next, a configuration example of the processing head HD according to Embodiment 1 will be described with reference to FIG. 2. FIG. 2 schematically shows a configuration example of the processing head HD according to Embodiment 1.

The processing head HD accommodates a first fiber coupling portion FC1 and a second fiber coupling portion FC2, a first collimator lens CL1 and a second collimator lens CL2, a mirror DM, a Galvano unit GU, a focus lens FL, and the protective glass PW in a housing along the Z direction.

The first fiber coupling portion FC1 is connected to the other end side (see above) of the optical fiber F1, and causes (guides) the first laser beam LB1 guided through the optical fiber F1 to enter the housing of the processing head HD.

The first collimator lens CL1 is an example of an optical element, and collimates the first laser beam LB1 spread from the first fiber coupling portion FC1.

The mirror DM can be driven in a direction MD (Z direction or −Z direction) based on, for example, drive control by the controller CON of a motor (not shown) disposed in the processing head HD. The mirror DM transmits the first laser beam LB1 to travel toward the focus lens FL, and reflects the second laser beam LB2 to travel toward the focus lens FL. The mirror DM may be implemented by a dichroic mirror.

The focus lens FL is an example of an optical element, and focuses the first laser beam LB1 collimated by the first collimator lens CL1 and the second laser beam LB2 collimated by the second collimator lens CL2 toward corresponding prescribed welding points of the workpiece WK. The focus lens FL may be a single lens or may be implemented by a plurality of lenses.

The protective glass PW prevents contamination in the processing head HD due to entry, into the processing head HD, of scattered and attached substances (for example, spatter and fumes) generated when the workpiece WK is irradiated with each of the first laser beam LB1 and the second laser beam LB2 and welded. The protective glass PW transmits each of the first laser beam LB1 and the second laser beam LB2 transmitted through the focus lens FL.

The second fiber coupling portion FC2 is connected to the other end side (see above) of the optical fiber F2, and causes (guides) the second laser beam LB2 guided through the optical fiber F2 to enter the housing of the processing head HD. The second collimator lens CL2 is an example of an optical element, and collimates the second laser beam LB2 spread from the second fiber coupling portion FC2. The collimated second laser beam LB2 travels toward the Galvano unit GU.

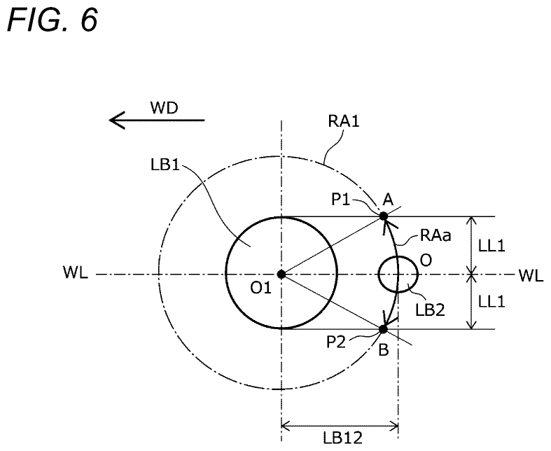

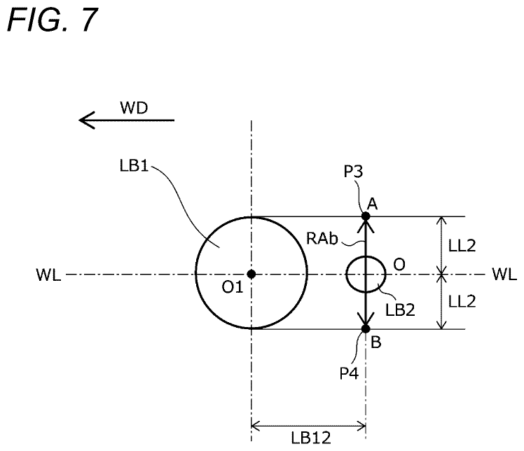

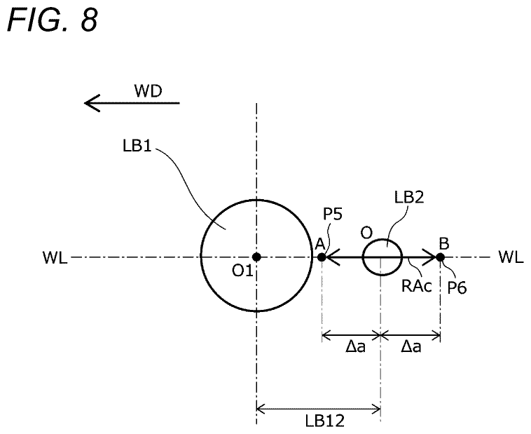

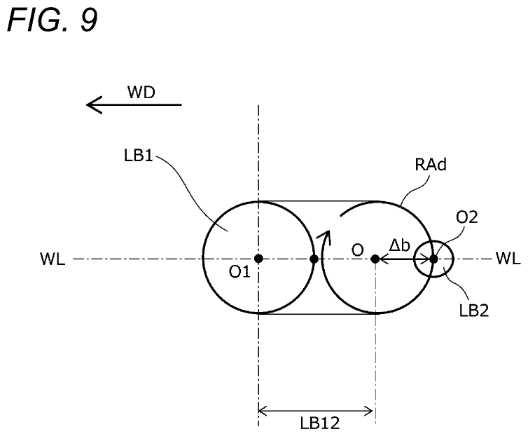

The Galvano unit GU controls each of an X-axis mirror MX and a Y-axis mirror MY along two axes in the X direction or the Y direction based on, for example, drive control by the controller CON of the motor (not shown) disposed in the processing head HD. The Galvano unit GU controls an irradiation position of the second laser beam LB2 on the workpiece WK by performing 2-axis control on each of the X-axis mirror MX and the Y-axis mirror MY. For example, the Galvano unit GU controls the irradiation position of the second laser beam LB2 with which the workpiece WK is irradiated along trajectories indicated by a first scanning trajectory RAa (see FIG. 6), a second scanning trajectory RAb (see FIG. 7), a third scanning trajectory RAc (see FIG. 8), and a fourth scanning trajectory RAd (see FIG. 9) described later.

An optical axis c-c′ shown in FIG. 2 is an optical axis of the first laser beam LB1 from the first fiber coupling portion FC1 toward a prescribed welding point on the workpiece WK. When entering the processing head HD from the first fiber coupling portion FC1, the first laser beam LB1 spreads and is collimated by the first collimator lens CL1. The first laser beam LB1 is collimated, transmitted through the mirror DM, focused by the focus lens FL, transmitted through the protective glass PW, and then radiated toward the prescribed welding point on the workpiece WK.

An optical axis d″″-d′ shown in FIG. 2 is an optical axis of the second laser beam LB2 from the second fiber coupling portion FC2 toward a prescribed welding point on the workpiece WK. Upon entering the processing head HD from the second fiber coupling portion FC2, the second laser beam LB2 spreads and is collimated by the second collimator lens CL2, and then travels toward the Galvano unit GU (optical axis d″″-d′″). The second laser beam LB2 is reflected by the X-axis mirror MX or the Y-axis mirror MY in the Galvano unit GU (optical axis d′″-d″) and travels toward the mirror DM (optical axis d″-d). The second laser beam LB2 is reflected by the mirror DM, focused by the focus lens FL, transmitted through the protective glass PW, and then radiated toward the prescribed welding point on the workpiece WK (optical axis d-d′).

Here, when both the X-axis mirror MX and the Y-axis mirror MY are located at an origin position by the Galvano unit GU, the optical axis (optical axis c-c′) of the first laser beam LB1 and the optical axis (optical axis d-d′) of the second laser beam LB2 are substantially parallel, and are radiated toward prescribed welding points on the workpiece WK at an inter-beam distance LB12. The inter-beam distance LB12 can be adjusted by a position of the mirror DM in the direction MD.

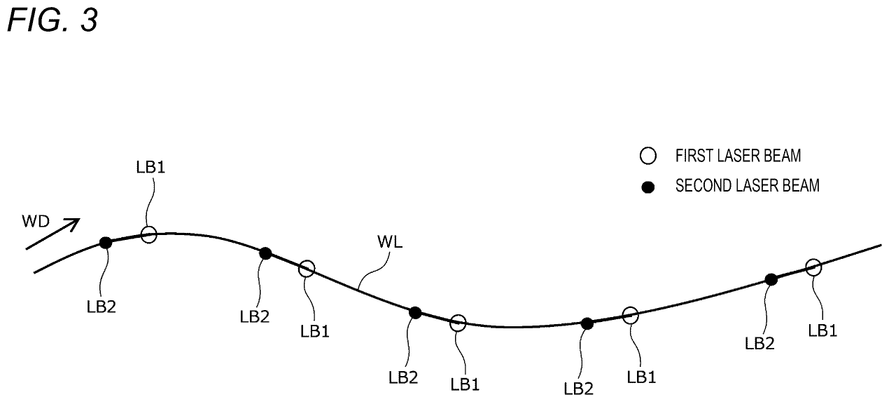

Next, an example of a positional relationship between the first laser beam LB1 and the second laser beam LB2 during welding will be described with reference to FIG. 3. FIG. 3 shows an example of the positional relationship between the first laser beam LB1 and the second laser beam LB2 relative to a weld line WL.

When the weld line WL is welded in a welding direction WD, the processing head HD radiates the first laser beam LB1, as well as the second laser beam LB2 along a prescribed trajectory (see FIGS. 6 to 9) to follow the first laser beam LB1, along the weld line WL. The first laser beam LB1 and the second laser beam LB2 are disposed such that a straight line connecting an optical axis O1 of the first laser beam LB1 and a scan center O (see FIGS. 6 to 9) of the second laser beam LB2 coincides with a tangent direction of the weld line WL, and a distance between the optical axis O1 (see FIGS. 6 to 9) of the first laser beam LB1 and the scan center O (see FIGS. 6 to 9) of the second laser beam LB2 is the inter-beam distance LB12.

### <3. Formation Example of Keyhole>

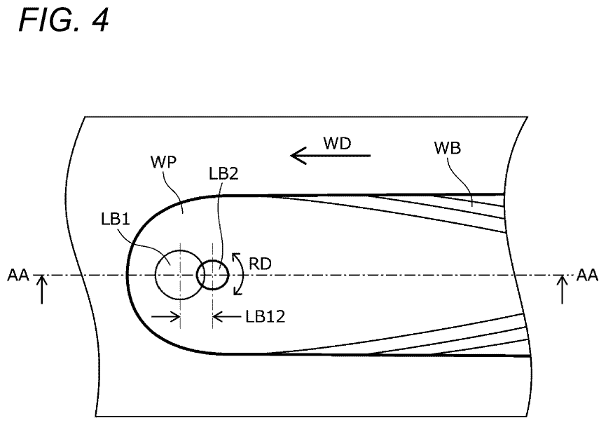

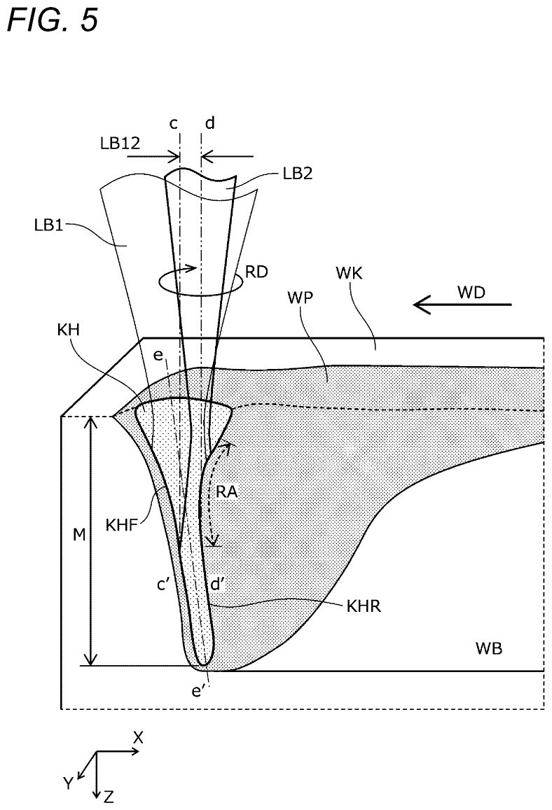

Next, an arrangement example of the first laser beam LB1 and the second laser beam LB2 and the keyhole KH formed by the first laser beam LB1 and the second laser beam LB2 in Embodiments 1 and 2 will be described with reference to FIGS. 4 and 5. FIG. 4 is a top view showing an arrangement example of the first laser beam LB1 and the second laser beam LB2. FIG. 5 is an AA-AA cross-sectional view showing an example of the melt pool WP and the keyhole KH in Embodiments 1 and 2.

The processing head HD rotates or performs scanning with the second laser beam LB2 in a direction RD at high speed and irradiates an irradiation area RA of the rear wall KHR of the keyhole KH with the second laser beam LB2, thereby restricting weld metal of the rear wall KHR from moving rearward in the welding direction WD and widening an interval between the front wall KHF and the rear wall KHR of the keyhole KH. Accordingly, the laser welding device 100 more effectively prevents the keyhole KH from being closed (that is, formation of closed spaces or bubbles), and prevents welding defects such as porosity or spatter that may occur when the keyhole KH is closed.

The first laser beam LB1 and the second laser beam LB2 are arranged apart at the prescribed inter-beam distance LB12 in the welding direction WD. The first laser beam LB1 is radiated to the workpiece WK (optical axis c-c′) to form the keyhole KH having a depth M. Although not shown, a depth L of the keyhole KH formed by the first laser beam LB1 is substantially equal to a penetration depth of the weld bead WB. The second laser beam LB2 is radiated to the rear wall KHR of the keyhole KH formed by the first laser beam LB1 (optical axis d-d′). Here, a central axis e-e′ of the keyhole KH formed by the first laser beam LB1 does not coincide with the optical axis c-c′ of the first laser beam LB1. Normally, the central axis e-e′of the keyhole KH has an inclination angle relative to the Z direction larger than an inclination angle of the optical axis c-c′ of the first laser beam LB1 relative to the Z axis.

The workpiece WK is irradiated with the first laser beam LB1 and the second laser beam LB2 to form the melt pool WP and the weld bead WB formed by solidification of the melt pool WP.

The inter-beam distance LB12 between the first laser beam LB1 and the second laser beam LB2 can be any distance, and the following relationship (Math. 1) is desirably satisfied.

$$LB 12 \leq w 1 + w 2 \qquad ( Math . 1 )$$

Here, a first beam radius w1 indicates a beam radius of the first laser beam LB1 on a surface of the workpiece WK. A second beam radius w2 indicates a beam radius of the second laser beam LB2 on the surface of the workpiece WK. When the second laser beam LB2 is rotated or used for scanning at a high speed, the inter-beam distance LB12 indicates a distance between an optical axis of the first laser beam LB1 and a rotation center or a scan center of the second laser beam LB2.

Further, the first beam radius w1 of the first laser beam LB1 and the second beam radius w2 of the second laser beam LB2 desirably satisfy the following relationship (Math. 2).

$$w 2 \leq w 1 \qquad ( Math . 2 )$$

### <4. Scanning Trajectory Examples of Second Laser Beam>

Next, scanning trajectory examples of the second laser beam LB2 will be described with reference to FIGS. 6 to 9.

### <4-1. First Scanning Trajectory Example>

FIG. 6 shows an example of the first scanning trajectory RAa of the second laser beam LB2. FIG. 6 shows an example in which the optical axis O1 of the first laser beam LB1 and the scan center O of the second laser beam LB2 are both located on the weld line WL.

The first scanning trajectory RAa is an arc-shaped trajectory having one end A and the other end B at two points P1, P2 where a circle RAI having the optical axis O1 of the first laser beam LB1 as a center point and the inter-beam distance LB12 as a radius intersect straight lines each parallel to the weld line WL at a vertical distance LL1 from the weld line WL. The vertical distance LL1 between the one end A, as well as the other end B, and the weld line WL is preferably equal to or less than the first beam radius w1 of the first laser beam LB1 (LL1≤w1).

The processing head HD controls the optical axis (not shown) of the second laser beam LB2 to reciprocate between two points (one end A and the other end B) on the first scanning trajectory RAa based on a processing program for laser welding.

### <4-2. Second Scanning Trajectory Example>

FIG. 7 shows an example of the second scanning trajectory RAb of the second laser beam LB2. FIG. 7 shows an example in which the optical axis O1 of the first laser beam LB2 and the scan center O of the second laser beam LB2 are both located on the weld line WL.

The second scanning trajectory RAb is a vertical line perpendicular to the weld line WL, and is a straight line having the one end A and the other end B at points P3, P4 each located at a distance of a vertical distance LL2 from the weld line WL. The vertical distance LL2 between the one end A, as well as the other end B, and the weld line WL is preferably equal to or less than the first beam radius w1 of the first laser beam LB1 (LL2≤w1).

The processing head HD controls the optical axis (not shown) of the second laser beam LB2 to reciprocate between two points (one end A and the other end B) on the second scanning trajectory RAb based on a processing program for laser welding.

### <4-3. Third Scanning Trajectory Example>

FIG. 8 shows an example of the third scanning trajectory RAc of the second laser beam LB2. FIG. 8 shows an example in which the optical axis O1 of the first laser beam LB1 and the scan center O of the second laser beam LB2 are both located on the weld line WL.

The third scanning trajectory RAc is a straight line having the one end A and the other end B at points P5, P6 each located at a distance Δa from the scan center O of the second laser beam LB2 in directions along the welding direction WD. The distance Δa between the one end A, as well as the other end B, and the scan center O of the second laser beam LB2 is preferably equal to or less than the first beam radius w1 of the first laser beam LB1 (Δa≤w1).

The processing head HD controls the optical axis (not shown) of the second laser beam LB2 to reciprocate between two points (one end A and the other end B) on the third scanning trajectory RAc based on a processing program for laser welding.

### <4-4. Fourth Scanning Trajectory Example>

FIG. 9 shows an example of the fourth scanning trajectory RAd of the second laser beam LB2. FIG. 9 shows an example in which the optical axis O1 of the first laser beam LB1 and the scan center O of the second laser beam LB2 are both located on the weld line WL.

The fourth scanning trajectory RAd is a circumference of a radius Δb that has the scan center O at a position rearward of the optical axis O1 of the first laser beam LB1 by the inter-beam distance LB12 in the welding direction WD. The radius Δb of the fourth scanning trajectory RAd is preferably equal to or less than the first beam radius w1 of the first laser beam LB1 (Δb≤w1).

The processing head HD controls rotation based on a processing program for laser welding such that an optical axis O2 of the second laser beam LB2 moves along the fourth scanning trajectory RAd.

### <5.2 Example of Scanning Speed Control of Second Laser Beam>

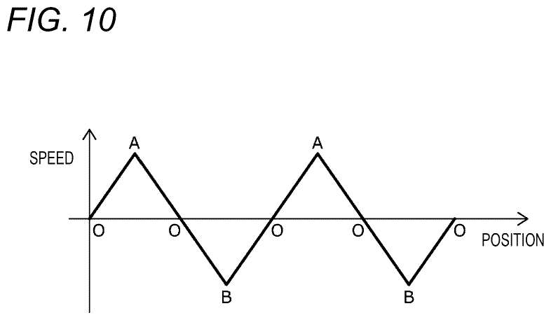

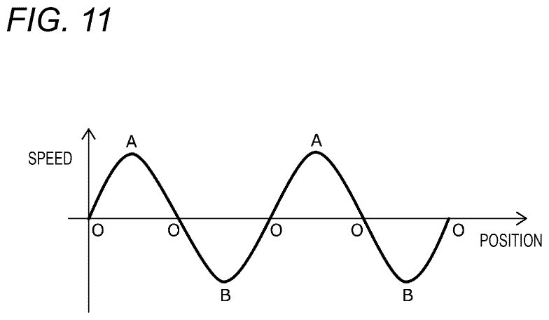

Next, a scanning speed of the second laser beam LB2 will be described. The scanning speed of the second laser beam LB2 in various trajectories (first scanning trajectory RAa to fourth scanning trajectory RAd shown in FIGS. 6 to 9) can be constant regardless of a beam position in a simplest case. In addition, it is desirable to adjust an interaction time with the keyhole KH according to an irradiation position and change the scanning speed according to the beam position to further stabilize the keyhole KH (FIGS. 6 to 8). The latter will be described with reference to FIGS. 10 and 11. FIG. 10 shows a first scanning speed control example of the second laser beam LB2. FIG. 11 shows a second scanning speed control example of the second laser beam LB2.

The processing head HD performs scanning with the second laser beam LB2 at a scanning frequency of 1 Hz to 10 kHz. In scanning speed graphs shown in FIGS. 10 and 11, a vertical axis represents speed, and a horizontal axis represents a position of the optical axis of the second laser beam LB2 (actual laser irradiation position). The horizontal axis indicates positions included in each scanning trajectory, including the one end A, the other end B, and the scan center O of the second laser beam LB2, which is a position rearward of the optical axis O1 of the first laser beam LB1 by the inter-beam distance LB12 along the welding direction WD.

The first scanning speed control graph shown in FIG. 10 shows a first scanning speed control example when the scanning speed of the second laser beam LB2 changes within a scan range (first scanning trajectory RAa to third scanning trajectory RAc) depending on the irradiation position. The processing head HD accelerates beam scanning in a forward direction toward the one end A, then accelerates the beam scanning in a reverse direction toward the other end B after reaching the one end A, and performs scanning with the second laser beam LB2 in the forward direction again after reaching the other end B. In the first scanning speed control graph, the scanning speed is changed at a constant ratio (acceleration, not shown) according to the irradiation position of the second laser beam LB2 in both the forward direction and the reverse direction, and the acceleration is changed to an opposite sign when the one end A or the other end B is reached. By performing the speed control described above, the speed of the second laser beam LB2 at the scan center O is slowest (that is, 0 (zero)), and thus the interaction time of the second laser beam LB2 at a point where a rear side of the keyhole KH in the welding direction WD intersects the weld line WL is longest, and the rear wall KHR of the keyhole KH can be further stabilized.

The second scanning speed control graph shown in FIG. 11 shows a second scanning speed control example when the moving speed of the second laser beam LB2 is changed according to an irradiation position in a scan range (first scanning trajectory RAa to third scanning trajectory RAc).

Here, the second scanning speed control graph shown in FIG. 11 is different from FIG. 10 in that acceleration of beam scan at the irradiation position on the horizontal axis is changed. In the case of the first scanning speed control graph shown in FIG. 10, since the sign of the acceleration is changed between the one end A and the other end B in addition to the above-described features, a sudden change in the acceleration occurs depending on conditions, and the beam gives a sudden impact to the keyhole KH at the one end A or the other end B, which may cause keyhole instability. Therefore, in the second scanning speed control graph shown in FIG. 11, the processing head HD accelerates the beam in the forward direction toward the one end A, then decelerates in a vicinity of the one end A, and then starts acceleration of the beam scan in the reverse direction toward the other end B after reaching the one end A. Accordingly, the scanning speed of the second laser beam LB2 is maximum at both the one end A and the other end B, but the acceleration is 0 (zero). For this reason, the beam has the smallest impact on the keyhole KH at the one end A and the other end B.

Since the scanning speed of the second laser beam LB2 at the scan center O is reduced by the above scanning speed control, the interaction time of the second laser beam LB2 at the point where the rear side of the keyhole KH in the welding direction WD intersects with the weld line WL is increased. In addition, since the acceleration of the beam scanning when the second laser beam LB2 reaches the one end A or the other end B of the scanning is 0 (zero), the impact applied to the keyhole KH by the second laser beam LB2 is minimum, and the rear wall KHR of the keyhole KH can be further stabilized.

In the second scanning speed control graph shown in FIG. 11, the relationship of the scanning speed relative to the position of each scan of the second laser beam LB2 (that is, the one end A, the other end B, and the scan center O) may be a sine wave.

The processing head HD moves, when rotating on the circumference indicated by the fourth scanning trajectory RAd, the irradiation position of the second laser beam LB2 along the fourth scanning trajectory RAd at the same speed or while changing the speed by the same control as the first scanning speed control or the second scanning speed control.

### Embodiment 2

The laser welding device 100 according to Embodiment 1 includes the processing head HD including the Galvano unit GU, and the Galvano unit GU controls the irradiation position (scanning position) of the second laser beam LB2. The laser welding device 100A according to Embodiment 2 includes a processing head HDA including a mirror unit MU, and an example in which the irradiation position (scanning position) of the second laser beam LB2 is controlled by the mirror unit MU will be described.

The laser welding device 100A according to Embodiment 2 has similar configurations as the laser welding device 100 described in Embodiment 1. Therefore, in the following description of the laser welding device 100A, only configurations different from those of the laser welding device 100 will be described.

The laser welding device 100A includes the first laser oscillator LOC1, the second laser oscillator LOC2, two optical fibers F1, F2, the processing head HDA, the manipulator MN, and the controller CON.

### <6. Configuration Example of Processing Head>

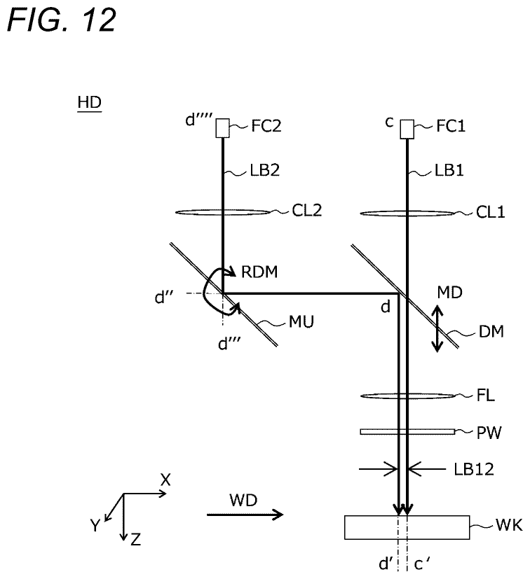

A configuration example of the processing head HDA according to Embodiment 2 will be described with reference to FIG. 12. FIG. 12 schematically shows the configuration example of the processing head HDA according to Embodiment 2.

The processing head HDA accommodates the first fiber coupling portion FC1 and the second fiber coupling portion FC2, the first collimator lens CL1 and the second collimator lens CL2, the mirror DM, the mirror unit MU, the focus lens FL, and the protective glass PW in a housing along the Z direction.

The mirror unit MU can perform scanning in a rotation direction RDM with one or both of the X axis and the Y axis as a central axis. The mirror unit MU implements scanning trajectories indicated by the first scanning trajectory RAa to the fourth scanning trajectory RAd by performing high-speed scanning with the second laser beam LB2.

The optical axis d″″-d′ shown in FIG. 12 is an optical axis of the second laser beam LB2 from the second fiber coupling portion FC2 toward a prescribed welding point on the workpiece WK. Upon entering the processing head HDA from the second fiber coupling portion FC2, the second laser beam LB2 spreads and is collimated by the second collimator lens CL2, and then travels toward the mirror unit MU (optical axis d″″-d′″). The second laser beam LB2 is used for scanning with one or both of the X axis and the Y axis as the central axis in the mirror unit MU (optical axis d′″-d″), and travels toward the mirror DM (optical axis d″-d′). The second laser beam LB2 is reflected by the mirror DM, focused by the focus lens FL, transmitted through the protective glass PW, and then radiated toward the prescribed welding point on the workpiece WK (optical axis d-d′).

### APPENDIXES

The following techniques are disclosed based on the above description of the embodiments.

### (Technique 1)

A laser welding device 100, 100A includes:
a first laser oscillator LOC1 configured to generate a first laser beam LB1;
a second laser oscillator LOC2 configured to generate a second laser beam LB2; and
a processing head HD, HDA configured to irradiate a workpiece WK with the first laser beam LB1 and the second laser beam LB2, in which
the first laser beam LB1 and the second laser beam LB2 are radiated substantially in parallel at a prescribed interval (inter-beam distance LB12) in a direction along a welding direction WD, and
the second laser beam LB2 is radiated toward a keyhole KH formed by the first laser beam LB1.

With this configuration, the second laser beam LB2 is radiated from rearward by the inter-beam distance LB12 in the welding direction. Accordingly, the laser welding device 100, 100A can prevent the keyhole KH formed by the first laser beam LB1 from being closed and more effectively prevent welding defects such as porosity or spatter.

### (Technique 2)

In the laser welding device 100, 100A according to (Technique 1),
the second laser beam LB2 is radiated to a rear side of the keyhole KH in a direction opposite to the welding direction WD.

With this configuration, the laser welding device 100, 100A can stabilize the unstable rear wall KHR inside the keyhole KH formed by the first laser beam LB1, prevent the keyhole KH from being closed, and more effectively prevent welding defects such as porosity or spatter.

### (Technique 3)

In the laser welding device 100, 100A according to (Technique 1) or (Technique 2),
the processing head HD, HDA controls an irradiation position of the second laser beam LB2 such that the second laser beam LB2 draws a prescribed trajectory (first scanning trajectory RAa, second scanning trajectory RAb, third scanning trajectory RAc, fourth scanning trajectory RAd).

With this configuration, the laser welding device 100, 100A radiates the second laser beam LB2 along a prescribed trajectory (first scanning trajectory RAa, second scanning trajectory RAb, third scanning trajectory RAc, and fourth scanning trajectory RAd) to further stabilize a shape in a wide range of the rear wall KHR of the keyhole KH formed by the first laser beam LB1, so that it is possible to more effectively prevent the keyhole KH from being closed and more effectively prevent welding defects such as porosity or spatter.

### (Technique 4)

In the laser welding device 100, 100A according to (Technique 3),
the prescribed trajectory (first scanning trajectory RAa) is an arc connecting two intersection points of two parallel straight lines parallel to a weld line WL of the workpiece WK and a circumference of a circle RAI centered on an irradiation position of the first laser beam LB1, and a distance between each of the parallel straight lines and the weld line is a first distance.

With this configuration, the laser welding device 100, 100A radiates the second laser beam LB2 along the prescribed trajectory (first scanning trajectory RAa) to further stabilize the shape in the wide range of the rear wall KHR of the keyhole KH formed by the first laser beam LB1, so that it is possible to more effectively prevent the keyhole KH from being closed and more effectively prevent welding defects such as porosity or spatter.

### (Technique 5)

In the laser welding device 100, 100A according to (Technique 3),
the prescribed trajectory (second scanning trajectory RAb) is a trajectory along an orthogonal direction orthogonal to a weld line WL of the workpiece, and is a line segment connecting two points at a second distance from the weld line.

With this configuration, the laser welding device 100, 100A radiates the second laser beam LB2 along the prescribed trajectory (second scanning trajectory RAb) to further stabilize the shape in the wide range of the rear wall KHR of the keyhole KH formed by the first laser beam LB1, so that it is possible to more effectively prevent the keyhole KH from being closed and more effectively prevent welding defects such as porosity or spatter.

### (Technique 6)

In the laser welding device 100, 100A according to (Technique 3),
the prescribed trajectory (third scanning trajectory RAc) is a trajectory along a direction connecting an irradiation position of the first laser beam LB1 and a scan center position of the second laser beam LB2, and is a line segment connecting two points each located at a third distance around a position separated from the first laser beam LB1 by the prescribed interval (inter-beam distance LB12).

With this configuration, the laser welding device 100, 100A radiates the second laser beam LB2 along the prescribed trajectory (third scanning trajectory RAc) to further stabilize the shape in the wide range of the rear wall KHR of the keyhole KH formed by the first laser beam LB1, so that it is possible to more effectively prevent the keyhole KH from being closed and more effectively prevent welding defects such as porosity or spatter.

### (Technique 7)

In the laser welding device 100, 100A according to (Technique 3),
the prescribed trajectory (fourth scanning trajectory RAd) is a circumference centered on a position separated from an irradiation position of the first laser beam LB1 by the prescribed interval (inter-beam distance LB12).

With this configuration, the laser welding device 100, 100A radiates the second laser beam LB2 along the prescribed trajectory (fourth scanning trajectory RAd) to further stabilize the shape in the wide range of the rear wall KHR of the keyhole KH formed by the first laser beam LB1, so that it is possible to more effectively prevent the keyhole KH from being closed and more effectively prevent welding defects such as porosity or spatter.

### (Technique 8)

In the laser welding device 100, 100A according to (Technique 7),
a radius of the circumference is equal to or less than a beam radius (first beam radius w1) of the first laser beam LB1.

With this configuration, the laser welding device 100, 100A can irradiate a scan range of the second laser beam LB2 within a range substantially equal to a width of the keyhole KH formed by the first laser beam LB1.

### (Technique 9)

In the laser welding device 100, 100A according to any one of (Technique 4) to (Technique 6),
the first distance, the second distance, or the third distance is equal to or less than a beam radius (first beam radius w1) of the first laser beam LB1.

With this configuration, the laser welding device 100, 100A can irradiate a scan range of the second laser beam LB2 within the range substantially equal to the width of the keyhole formed by the first laser beam LB1.

### (Technique 10)

In the laser welding device 100, 100A according to (Technique 1),
the first laser beam LB1 and the second laser beam LB2 are radiated in an order of the first laser beam LB1 and the second laser beam LB2 in the welding direction.

With this configuration, the laser welding device 100, 100A can irradiate the rear side of the keyhole KH formed by the first laser beam LB1 with the second laser beam LB2.

### (Technique 11)

In the laser welding device 100, 100A according to (Technique 1),
a beam radius (first beam radius w1) of the first laser beam LB1 is equal to or larger than a beam radius (second beam radius w2) of the second laser beam LB2.

With this configuration, the laser welding device 100, 100A can irradiate a vicinity of a rear wall of the keyhole formed by the first laser beam LB1 with the second laser beam LB2.

### (Technique 12)

In the laser welding device 100, 100A according to (Technique 1),
the processing head HD, HDA includes a Galvano unit GU configured to control an irradiation position of the second laser beam LB2.

With this configuration, the laser welding device 100, 100A can perform scanning with the second laser beam LB2 at high speed.

### (Technique 13)

In the laser welding device 100, 100A according to (Technique 1),
the processing head HD, HDA includes a mirror (mirror unit MU) configured to control an irradiation position of the second laser beam LB2 on a two-dimensional coordinate.

With this configuration, the laser welding device 100, 100A can perform scanning with the second laser beam LB2 at high speed.

### (Technique 14)

A laser welding method performed by a laser welding device 100, 100A, the laser welding device 100, 100A including:
a first laser oscillator LOC1 configured to generate a first laser beam LB1;
a second laser oscillator LOC2 configured to generate a second laser beam LB2; and
a processing head HD, HDA configured to irradiate a workpiece WK with the first laser beam LB1 and the second laser beam LB2, includes:
radiating the first laser beam LB1 and the second laser beam LB2 substantially in parallel at a prescribed interval (inter-beam distance LB12) in a direction along a welding direction WD; and
radiating the second laser beam LB2 toward a keyhole KH formed by the first laser beam LB1.

With this configuration, the second laser beam LB2 is radiated from rearward by the inter-beam distance LB12 in the welding direction. Accordingly, the laser welding device 100, 100A can prevent the keyhole KH formed by the first laser beam LB1 from being closed and more effectively prevent welding defects such as porosity or spatter.

Although the embodiments have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the embodiments described above may be combined freely in a range without departing from the spirit of the invention.

The present application is based on a Japanese patent application filed on Jul. 14, 2023 (JP2023-116130A), and contents thereof are incorporated herein by reference.

### INDUSTRIAL APPLICABILITY

The present disclosure is useful as a laser welding device and a laser welding method that more effectively prevent welding defects such as porosity or spatter.

What is claimed is:

1. A laser welding device comprising:
a first laser oscillator that generates a first laser beam;
a second laser oscillator that generates a second laser beam; and
a processing head that irradiates a workpiece with the first laser beam and the second laser beam, wherein
the first laser beam and the second laser beam are radiated in parallel at a prescribed interval in a direction along a welding direction, and
the second laser beam is radiated toward a keyhole formed by the first laser beam.

2. The laser welding device according to claim 1, wherein
the second laser beam is radiated to a rear side of the keyhole in a direction opposite to the welding direction.

3. The laser welding device according to claim 1, wherein
the processing head controls an irradiation position of the second laser beam such that the second laser beam draws a prescribed trajectory.

4. The laser welding device according to claim 3, wherein
the prescribed trajectory is an arc connecting two intersection points of two parallel straight lines parallel to a weld line of the workpiece and a circumference of a circle centered on an irradiation position of the first laser beam, and a distance between each of the intersection points and the weld line is a prescribed distance.

5. The laser welding device according to claim 3, wherein
the prescribed trajectory is a trajectory along an orthogonal direction orthogonal to a weld line of the workpiece, and is a line segment connecting two points at a prescribed distance from the weld line.

6. The laser welding device according to claim 3, wherein
the prescribed trajectory is a trajectory along a direction connecting an irradiation position of the first laser beam and the irradiation position of the second laser beam, and is a line segment connecting two points each located at a prescribed distance around a position separated from the first laser beam by the prescribed interval.

7. The laser welding device according to claim 3, wherein
the prescribed trajectory is a circumference centered on a position separated from an irradiation position of the first laser beam by the prescribed interval.

8. The laser welding device according to claim 7, wherein
a radius of the circumference is equal to or less than a beam radius of the first laser beam.

9. The laser welding device according to claim 4, wherein
the prescribed distance is equal to or less than a first beam radius of the first laser beam.

10. The laser welding device according to claim 1, wherein
the first laser beam and the second laser beam are radiated in an order of the first laser beam and the second laser beam in the welding direction.

11. The laser welding device according to claim 1, wherein
a beam radius of the first laser beam is equal to or larger than a beam radius of the second laser beam.

12. The laser welding device according to claim 1, wherein
the processing head includes a Galvano unit capable of controlling an irradiation position of the second laser beam.

13. The laser welding device according to claim 1, wherein
the processing head includes a mirror that controls an irradiation position of the second laser beam on a two-dimensional coordinate.

14. A laser welding method performed by a laser welding device, the laser welding device including
a first laser oscillator that generates a first laser beam,
a second laser oscillator that generates a second laser beam, and
a processing head that irradiates a workpiece with the first laser beam and the second laser beam,
the laser welding method comprising:
radiating the first laser beam and the second laser beam substantially in parallel at a prescribed interval in a direction along a welding direction; and
radiating the second laser beam toward a keyhole formed by the first laser beam.
